(19) United States
(12) Patent Application Publication
(10) Pub. No.: US 2018/0192596 A1
(43) Pub. Date: Jul. 12, 2018

(54) GREENHOUSE

(71) Applicant: PURE GLASS GREENHOUSE LTD, Weston-Super-Mare (GB)

(72) Inventor: Matthew James HOWIS, Frome (GB)

(21) Appl. No.: 15/737,726

(22) PCT Filed: Jun. 17, 2016
(86) PCT No.: PCT/EP2016/064072

§ 371 Date: Dec. 18, 2017

(30) Foreign Application Priority Data
Jun. 18, 2015 (GB) 1510747.7

(51) Int. Cl. A01G 9/16

(52) U.S. Cl. CPC A01G 9/16

(57) ABSTRACT

A freestanding, frameless greenhouse (1), the greenhouse comprising a plurality of transparent panels (2, 3, 4, 5) which are fastened together by a plurality of connectors (14) to form a wall (2, 4) and a roof (5), wherein the wall and roof enclose an interior.

### TECHNICAL FIELD

The present invention relates generally to freestanding, frameless greenhouses, kits for building such greenhouses, and assemblies comprising such greenhouses and a base.

### BACKGROUND ART

Greenhouses are outdoor structures used to provide a controlled environment for growing plants. Traditional greenhouses have frames made of aluminium, wood or plastic compounds. Glass or transparent plastic panes are inserted or attached to the frame. Traditional greenhouses have a door for entering and exiting the greenhouse, wherein the door has a surrounding frame that is hinged to a frame surrounding an opening for the door.

### DISCLOSURE OF THE INVENTION

The present inventors have identified numerous problems with existing greenhouse designs, including their appearance when constructed and placed in e.g. a garden of a residential property, the fact that they can be difficult and time consuming to construct, their durability and/or strength, difficulties in moving them, safety problems with broken glass, the accumulation of dirt and pests, and difficulties in cleaning and sterilising the greenhouses. The present invention may address one or more of these problems.

At its most general, the present invention provides a freestanding greenhouse that does not have a frame, wherein the greenhouse structure is formed of a plurality of transparent panels connected together by connectors.

According to a first aspect of the present invention there is provided a freestanding, frameless greenhouse, the greenhouse comprising a plurality of transparent panels which are fastened together by a plurality of connectors to form a wall and a roof, wherein the wall and the roof enclose an interior.

Thus, the greenhouses of the invention are freestanding and frameless.

By ‘freestanding’ it is meant that the greenhouse is a stand-alone structure, in other words it is not structurally supported by another structure, such as a building. Put another way, the greenhouse is self-supporting, i.e. the greenhouse structure supports its own weight. The term “freestanding” includes the possibility that the base of the greenhouse is positioned in a groove or channel, or is surrounded by a lip or edge, to prevent lateral movement of the greenhouse.

By ‘frameless’ it is meant that the greenhouses (i.e. the weight of the greenhouses) are not supported by a framework or scaffold. The panels which form the walls and roof are frameless (i.e. the panels do not have a supportive surround), and there is no framework outside or within the structure to support the panels. Thus the panels and connectors themselves are sufficient to support the frameless greenhouse, for example because of the strength of the panels and the strength of the fastening provided by the connectors. Thus, as mentioned above, greenhouses of the invention may also be described as self-supporting. The greenhouses do not require any further support to remain upright. The term “frameless” includes the possibility that the base of the greenhouse is positioned in a groove or channel, or is surrounded by a lip or edge, to prevent lateral movement of the greenhouse.

This unique frameless design makes the greenhouses of the invention strong structures. The structural strength also makes the greenhouses of the invention weather resistant and safe structures.

Traditional greenhouses have large numbers of panes and are complicated to construct, making assembly slow and difficult. Additionally, these structures often have loose panes which can be difficult to replace, and can lead to leaks. The loose pains also cause a risk of serious injury. By contrast, the greenhouses of the present invention are easy and quick to assemble. For example, a greenhouse of the invention may take as little as 30 minutes to a couple of hours to assemble, while traditional greenhouses can take the best part of two days to assemble. This quick assembly time for greenhouses of the invention makes them much easier to move/relocate, as deconstruction time is also reduced.

The increased speed of construction of the present invention is due to the ease with which the panels can be connected together individually using the connectors. This also eliminates the problem of loose panes, thus making the greenhouse of the invention safer for users.

The greenhouses of the invention are also easy to sterilize and clean. Traditional framed greenhouses have many nooks and crannies where pests, including disease spreading organisms, spores or other material, and dirt can accumulate. The presence of gaps between frame and the panes, or in the frame itself, makes it difficult to clean traditional greenhouse, and difficult to remove pests such as slugs and snails. Additionally, the frame acts a barrier to cleaning the edges of the panels. By contrast, the frameless greenhouses of the present invention are much easier to clean. The lack of frame makes it possible to clean across joins between panels. The joins are barely visible, giving seamless effect, which is both aesthetically pleasing and easy to clean. The frameless design means there are significantly fewer corners and crevices for dirt to accumulate in.

The absence of a frame also allows more sunlight into the greenhouse, and easier cleaning means that panels can by readily cleaned to prevent dirt from obstructing the light.

The transparent panels are fastened together using connectors. In other words, the panels are secured together by the connectors. The connectors may take a number of different forms, and suitable connectors are known to the skilled person. The connectors do not frame or surround the panels (the greenhouse is frameless), but fasten the panels together at distinct loci or positions.

The wall(s) and roof of the greenhouse of the invention enclose an interior. By ‘enclose’ it is meant that the interior is surrounded on all sides (except the base, which in practice will be enclosed by the surface on which the greenhouse is positioned). The walls surround the interior at the sides, and the roof from above. In other words, when the greenhouse is placed on a base, the interior is surrounded by the base at the bottom, the roof at the top and walls at the sides.

Enclosing an interior does not preclude the presence of air vents in the walls and/or roof, and a door as described elsewhere herein.

The panels are fastened/secured together by connectors to form the wall(s) and roof of the greenhouse. Panels which form the walls may be referred to as ‘wall panels’, and panels which form the roof may be referred to as ‘roof panels’. The term panels may mean sheets, or panes.

Greenhouses of the invention may be used to grow or keep plants, but can also be used for other purposes, such as a seating area or summer house. The greenhouses of the invention may be placed in outdoor spaces, such as gardens.

Being fastened together means the positions of the panels are fixed relative to each other. In other words, the connectors prevent the panels from moving relative to each other.

The term greenhouse as used in the present invention may mean a structure that is intended for growing plants. The term greenhouse may mean a single story structure. The term greenhouse may mean a structure of an appropriate size for positioning in a garden of a residential property

The greenhouse according to the first aspect of the invention may have any one, or, to the extent they are compatible, any combination of the following optional features.

The greenhouse of the invention may have a plurality of walls. In other words, the panels form a plurality of walls, for example 3, 4, 5, 6, 7, 8 or more walls. In some embodiments, the greenhouse has 4 walls. In other words, in some embodiments the walls of the greenhouse enclose a three-dimensional rectangular shape interior, or a cuboid interior. Each of the walls is at an angle relative to the adjacent wall. Each wall may be formed by a single one of the panels, or by more than one of the panels.

The walls may be straight (not curved). The walls may be formed from straight (non-curved) panels.

The greenhouse may have a rectangular footprint, i.e. it may have four walls, where adjacent walls are at right angles to each other.

The greenhouse of the invention may have a door. In other words, the greenhouse may have an opening in a wall, and door for covering the opening.

The door is a size appropriate for a person to use. Thus the door allows a person to access the interior of the greenhouse.

The opening for the door may be at least 160 cm tall, and at least 55 cm wide. The opening may be between 55 and 110 cm or 55 and 100 cm wide, through wider opening may also be used. The opening may be between 160 cm and 190 cm tall and at least 55 cm wide. The opening may be between 170 cm and 220 cm tall and 70 cm and 85 cm wide.

Where the greenhouse has a single door opening, the wall with a door may be referred to as the ‘front wall’. Where the greenhouse also has a rectangular footprint, the opposing wall may be referred to as the ‘rear wall’. The walls abutting the wall with a door may be referred to as ‘side walls’.

The door for covering the opening may take any one of a number of configurations. For example, the door may be a swing/hinged door, a sliding door or a folding door. The terms ‘hinged door’ and ‘swing door’ are used interchangeably herein.

The door may comprise a handle, and a latch. The door may also comprise a lock.

The bottom of the door may be held slightly higher than the bottom of the walls, for example 2-8 mm higher, to allow it to move freely to open and close the door. Preferably there is no door threshold. This would allow easy access for wheelbarrows or wheelchairs, for example.

The door may be made of a transparent panel. Transparent doors do not obstruct light from reaching the interior of the greenhouse. The door transparent panel may be made of any of the materials disclosed for other transparent panels (i.e. wall and roof panels) herein. The door may be made of the same material as the wall and roof panels. The door panel may also be the same thickness as the wall and roof panels.

The door may be made of glass, for example toughened glass. Alternatively the door may be made of plastic, for example Perspex.

A single opening may be coverable by more than one door. In other words, the greenhouse may comprise multiple doors for covering an opening. For example 2 doors may be used to cover a single opening. Where more than one door, for example two doors, are present for covering an opening they may be sliding doors, or swing/hinged doors for example.

In some embodiments the greenhouse may comprise two sliding doors for covering an opening. The doors may slide across the opening from opposite sides of the opening.

In some embodiments the greenhouse may comprise two hinged doors for covering an opening. The doors may each be attached to the wall panel at opposite sides of the opening. Such door may be referred to as ‘double doors’ or ‘double swing doors’.

In embodiments with a plurality of doors, each door may be made of a transparent panel. The door transparent panels may be made of any of the materials disclosed for other transparent panels herein.

In greenhouses having one or more doors, a door may be a swing or folding door, e.g. a swing door. For example, the door may be attached to a wall panel by hinges. Suitable hinges are known to the skilled person. The hinges may be screwed or bolted to the wall panels and door. In some embodiments the door and wall have a hole for receiving a screw or bolt. Thus the hinges may be fastened to the wall and/or door by screws or bolts through the holes in the wall and/or door. The door may be held about 2-10 mm from the abutting panel or panels.

A swing door may be directly attached to one of the panels by a hinge. Directly attached means that the hinge is fixed to both the panel and the door without there being any intermediate connecting parts. Where the door is made of a transparent panel, the transparent panel of the door may be directly attached to the panel by the hinge, so that the hinge is fixed to both the panel and to the transparent panel of the door.

Where a hinge is used, the door and wall panel may be adapted to receive the hinge mechanism. For example, panels may have a recess for receiving the hinge.

The greenhouse may comprise a plurality of doors. In other words, the greenhouse may have a plurality of openings in the wall(s) and doors for covering those openings.

The greenhouse may have an air vent. Preferably the greenhouse has a plurality of air vents. In some embodiments there are a plurality of vents in a single wall panel. The vents are suitable for allowing airflow between the interior and exterior of the greenhouse. The air vents allow the greenhouse to be well ventilated, which is advantageous for regulating temperature and humidity, and keeping plants.

A vent may be a hole in a wall or roof panel. A panel may have a plurality of such vent holes. A vent hole may be circular, for example about 2-15 cm in diameter, for example, about 5-12 cm, 7-12 cm or 9-11 cm in diameter.

Other vent shapes may also be used. Generally, a single vent would not exceed 1800 cm² in area. Single vents may be much smaller than this area, for example, smaller than 1600 cm², 1200 cm² or 1000 cm².

In preferred embodiments the vent(s) are on a wall panel. The greenhouse may have vents in multiple walls. The greenhouse may have vents in non-adjacent walls. For example, where the greenhouse has a rectangular footprint, vents may be located in opposing walls.

One, some or all of the vents may be closable. In these embodiments the greenhouse may comprise a movable covering for the vents. The covering is movable between an open position and a closed position. In the open position, air may flow through the vent. In the closed position airflow is restricted. The movable covering may be transparent, for example a transparent panel. A moveable covering, may be a panel which is slidable to cover a vent hole.

A vent may comprise a tiltable or pivotable panel, for example a tiltable transparent panel. By ‘tiltable’ or ‘pivotable’ it is meant that the panel may be tilted or rotated about a pivot in such a way that it is moveable from a closed position in which it is flush with the wall or roof of the greenhouse, toward an open position in which it is no longer flush, but tilted relative to the wall or roof panel. Air can flow freely between the interior and exterior of the greenhouse in the open position. Such vents many be referred to as ‘window vents’ or ‘tilting vents’.

In some embodiments, the greenhouse comprises a tilting vent and a plurality of other vent holes. In some embodiments the tilting vent is in a different panel to the other vent holes.

In some embodiments the greenhouse comprises a large vent, for example a single large vent, and a plurality of smaller vents. The smaller vents may be on a different panel to the large vent. The large vent may be about 600 to 1800 cm² in area, while the small vent may be about 5 to 600 cm² in area.

The greenhouse may have a tilting vent above the door. In one embodiment, where the greenhouse has a dual-pitched roof, and a door on the wall under the ridge (not the eaves), there is a tilting vent between the top of the door and the ridge of the roof. Such a vent may be triangular in shape. Where there is a tilting vent above the door, there may be a further vent or plurality of vents on the opposing wall.

The terms ‘vent’ and ‘air vent’ are used interchangeably herein.

The transparent panels are secured together using connectors. Each connector may be configured to secure/fasten adjacent panels together. Each of the connectors may be configured to secure/fasten two panels together.

Each panel may be fastened to a neighbouring panel by a single connector or a plurality of connectors. For example a panel may be fastened to an adjacent panel with 1-3 connectors, e.g. 1 or 2 connectors.

The connectors may fasten the panels together by gripping the panels. The connector may have two arms, each abutting an opposite face of the panel. The arms may be connected to each other by a screw or bolt, for example a screw or bolt that passes through a hole in the panel.

The connectors may be attached to the panels using screws or bolts. The panels may have holes for receiving the screws or bolts. Thus the connectors may be fastened to the panels using screws or bolts, which are secured through holes in the panels.

The connectors may be made of materials such as metal, for example brass, glass or plastics.

The connectors may fasten the panels a few millimetres apart, for example less than about 5 mm, 4 mm, 3 mm, 2 mm, or 1 mm apart. The connectors may fasten the panels so that they are abutting. The connectors may fasten the panels about 0-3 mm apart, for example 1-3 mm, or 1.5-2.5 mm apart.

The connectors may be clamps.

The transparent panels may be made of known transparent materials such as glass or plastic. Preferably the panels are made of toughened material, for safety reasons. However, this is not essential. The panels may be made of shatter-resistant material.

The panels may be glass panels. The glass may be safety glass. The glass may be toughened glass. The glass may be tempered glass. The glass may be toughened tempered glass. Alternatively laminated glass may be used. Use of toughened glass is advantageous because of its strength, which makes it less likely to break, and makes the greenhouse structure stronger. Additionally, toughened glass does not break into shards (rather it shatters completely) when broken, which makes the glass safer as a person is less likely to injure themselves.

Plastic panels may be made of Perspex, for example.

The roof of the greenhouse is formed by at least one panel. In preferred embodiments, the roof is a pitched roof. The pitch allows water to run off the roof.

The roof may be dual-pitched. Dual-pitched roofs may also be referred to as double-pitched roofs. These roofs have a single ridge, with two faces which slope down from the ridge. Where the roof is dual-pitched, it may be formed from 2 panels.

In some embodiments, the roof overhangs the wall(s). The overhang may be on all of the walls (e.g. a gable roof) or some of the walls.

In some embodiments, where the roof is dual-pitched, the roof may overhang the walls to form eaves. For example, the roof may overhang two opposing walls to form eaves. The roof may overhang the side walls of the greenhouse.

Overhang of the roof may be useful for collecting water from the roof, for example, and to keep water away from the roof-wall join.

In other embodiments the roof does not overhang the wall. In other words the edge of the roof is flush with the top of the wall.

In some embodiments, the greenhouse has sealant in the join between adjacent panels. This allows the greenhouse to be fully weatherproofed by restricting flow of water and air between the panels. Sealant in the join between panels also prevents pests, spores and other objects from getting into the gaps, making cleaning of the greenhouse much easier. The greenhouse may have sealant in the joins between adjacent panels which form the walls and roof. Sealant may be in all of the panel joins except those with moving parts. Put another way, sealant is not applied to joins between panels and the door and vent(s)).

Suitable sealants are known to the skilled person. For example, the sealant may be glass or glazing sealant, preferably structural glass/glazing sealant. Such sealants are typically silicone containing. The sealant may be transparent or translucent.

The sealant may create an airtight seal between panels. As described herein, the greenhouses may have air vents. It is advantageous to have sealant in the joins in combination with air vents, as the combination results in a draw effect, allowing air to be drawn through the greenhouse. Thus greenhouses comprising sealant in joints between the panels and air vents have excellent ventilation.

Thus, in some embodiments, the greenhouse comprises sealant in joins between adjacent panels, and a plurality of vents.

By comparison, traditional framed greenhouses often suffer from leaks, and are not airtight, so do not get the same draw effect which is advantageous for ventilation.

The greenhouse of the invention may further comprise a manifestation on one or more of the wall and/or roof panels. In other words the greenhouse may have film on one or more of the wall and/or roof panels. A manifestation is a film which is stuck to the glass. The manifestations make also be referred to as ‘glass manifestations’ or ‘film’ or ‘adhesive film’, though the term ‘manifestations’ is widely used in the art.

Manifestations may be opaque, reflective, translucent or transparent, for example. Some manifestations may have filters which filter out light, for example a UV-filter to filter out UV light.

Manifestations may be placed to control the greenhouse environment. For example a manifestation may be used to create shade in the greenhouse. Such a manifestation may be referred to as a ‘shading manifestation’. Depending on the orientation of the greenhouse in situ, manifestations may be placed on different panels to create the desired shading or lighting effect.

A manifestation may cover some or all of a panel.

The panels may be at least about 5 mm thick, preferably at least about 6, 7, 8, 9, 10 or 12 mm thick. In some embodiments the panels are about 5-30, 5-25, 5-20 or 5-15 mm thick. The panels may be about 7-12 mm thick for example. The panels may be about 10 mm thick.

Use of thick panels, such as 7-12 mm, reduces the risk of breakage and provides greater insulation.

Greenhouses of the invention may be described as single-glazed. In other words, the wall may be a single panel thick.

In some embodiments, the greenhouse has a wall formed from 1 or 2 panels. Preferably, a wall of the greenhouse is formed from a single panel. The greenhouse may have a plurality of walls, each formed form a single panel. As described above, the greenhouse may have a door in one of the walls. The wall with a door may be formed from a single panel, with a cut-out for the door. Alternatively that wall may be formed from 2 or 3 panels (excluding the door).

Accordingly, in a preferred embodiment, the roof is formed from 1 panel (mono-pitched) or 2 panels (dual-pitched), and each wall is formed from a single panel, with the exception of the wall having a door which is formed of 1 to 3 panels (not including the door).

Accordingly, the greenhouse walls and roof together, may be formed from around 6 to 10 panels, preferably 6 to 8 panels. This low number of panels allows assembly of the greenhouse to be quick and simple.

Generally the greenhouses are single storey structures. The greenhouses are large enough to accommodate a person. For example the greenhouse may be at least about 1.6 m, 1.7 m, 1.8 m or 1.9 m tall. The greenhouse may be less than about 4 m, 3.5 m 3 m, 2.9 m, 2.8 m, 2.7 m, 2.6 m, 2.5 m, 2.4 m, 2.3 m, 2.2 m, 2.1 m or 2 m tall. The greenhouse may be about 1.5-4 m, preferably about 1.6-2.5 m tall, for example 1.8-2.2 m tall.

In some embodiments, the minimum dimensions of the greenhouse footprint are about 1×1 m. In some embodiments, the maximum dimensions of the greenhouse footprint are about 8×8 m. The greenhouse footprint may be in the region of 1×1 m to 8×8 m, for example about 1×1 m to 5×5, 1×1 to 3×3 m, 1×1 m to 2×2 m. The greenhouse footprint may be between about 1×2 and 4×8 m, for example.

The ‘footprint’ is the shape of the base of the walls of the greenhouse. The footprint is measured by measuring the dimensions of the greenhouse at the base of the walls, where the two measurements are taken at right angles to one another.

According to another aspect, the invention provides a kit-of-parts comprising a plurality of transparent panels and a plurality of connectors for assembling into a greenhouse according to the first aspect of the present invention, optionally with one or more of the optional features described above.

Such kits may also comprise any necessary bolts for attaching the connectors to the panels. Optionally, kits may comprise tools for assembling the greenhouse. The kits may contain instructions for assembling the greenhouse.

Kits may also comprise sealant. Possible sealants are described in more detail above.

Kits may also comprise a manifestation. In some embodiments the kit may comprise a plurality of manifestations. Possible manifestations are described in more detail above.

Kits may also comprises a channel or track for receiving the wall panels, i.e. the bottom edge of the wall panels. The channel may help to prevent lateral movement of the greenhouse, but is not necessary. In other words, the greenhouse can stand without such a channel. Such a channel may be made of a number of materials, including metal, for example stainless steel, wood, plastic or glass.

Kits of the invention may be described as flat-pack kits.

According to a further aspect, the present invention provides an assembly of a greenhouse according to the first aspect of the present invention, optionally with any one or more of the optional features described above, and a base, wherein the greenhouse rests on the base.

Due to the self-supporting nature of the greenhouse, it can be rested on a surface or base to enclose an interior. Surfaces used for conventional greenhouses are suitable for use as a base for the present invention.

The base may simply be a level surface. For example, the base may be a concrete or paved surface. The base may be a perimeter base. A perimeter base has a surface complementary to the footprint of the greenhouse, or to the base of the walls, for resting the greenhouse on. This surface may be made of wood, steel or brick for example.

The base may be adapted to receive the wall panels. For example, the base may comprise a channel or groove adapted to receive the wall panels, i.e. the bottom edges of the wall panels. The base may be a perimeter base, where the surface has a channel or groove adapted to receive the wall panels. The channel or groove may also be referred to as a track. In some embodiments the channel is raised above base.

The channel may be made of a number of materials, including metal, as described above.

Sealant may be placed between the wall and base, for example to form an airtight seal.

The invention will now be further described with reference to the following non-limiting figures and examples. Other embodiments of the invention will occur to those skilled in the art in the light of these.

### FIGURES

FIG. 1 is an illustration of a greenhouse of the invention.

FIG. 2 is a diagram of a rear, first side, front and second side views of a greenhouse of the invention.

FIG. 3 is a diagram of a rear wall panel in a greenhouse of the invention.

FIG. 4 is a diagram of front, rear and side views of a greenhouse of the invention.

FIG. 5 is a schematic of assembled panels of an embodiment of the greenhouse. In this figure the door is shown out of position.

### EXAMPLES

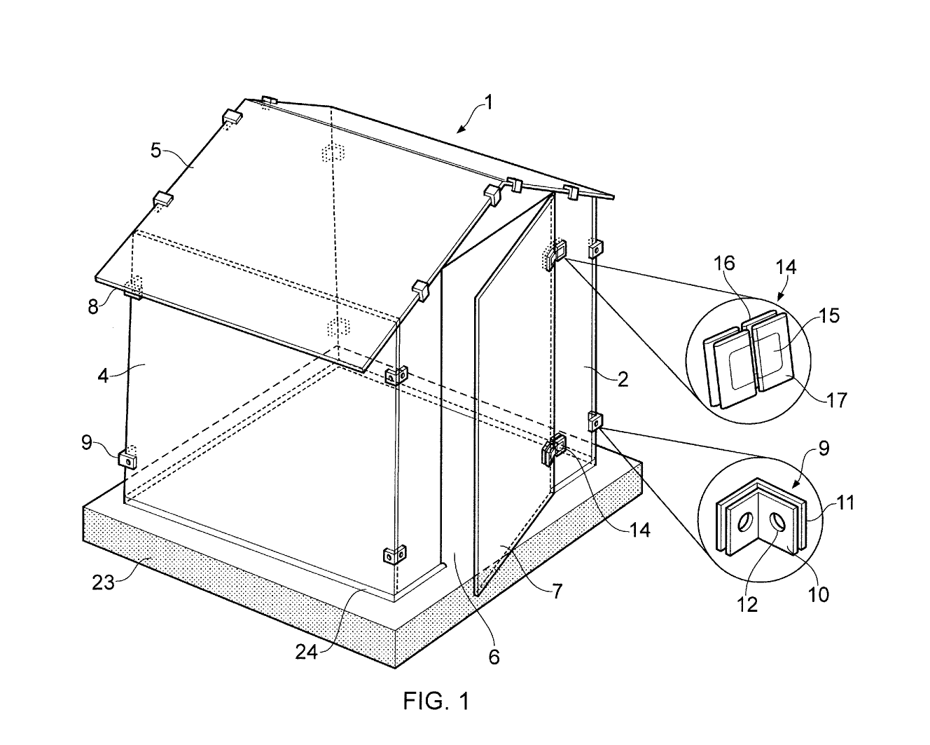

A greenhouse according to an embodiment of the invention is illustrated in FIG. 1.

The greenhouse (1) is formed of a front wall (2), a rear wall (3), two side walls (4) and a roof (5). The front wall, rear wall and two side walls (2,3,4) are positioned at right angles to each other to form a rectangular footprint. The side walls (4) and the rear wall (3) are each formed from a respective single transparent panel. In contrast, the front wall (2) is formed from three transparent panels which are arranged to provide an opening (6) for a door (7) (described later). Specifically, two of the panels of the front wall (2) are positioned to either side of the opening for the door, and the further panel of the front wall (2) has a triangular shape and is positioned above the opening (6) for the door (7) between the opening (6) and the roof (5). Of course, in other embodiments the front wall (2) may be formed from a single panel.

The front and rear walls (2,3) are longer than the side walls (4).

The roof (5) is double-pitched and is formed from two transparent panels. The panels of the roof (5) overhang the panels of the side walls to provide eaves (8) at the sides of the greenhouse. However, the panels of the roof (5) are flush with (do not overhang) the panels of the front and rear walls (2,3). Of course, in other embodiments the panels of the roof (5) may overhang the panels of all of the walls, or none of the walls.

In the embodiment shown in FIG. 1, the panels used to form the walls (2,3,4) and the roof (5) are glass panels, specifically 10 mm thick toughened glass panels. Such glass has excellent strength and toughness properties, and thus can safely support the weight of the greenhouse and be suitably resistant to damage.

The panels are fastened together by clamps (9), such as those obtainable from C.R. Laurence Company, Inc. For example 90° glass-to-glass application glass clamps may be used.

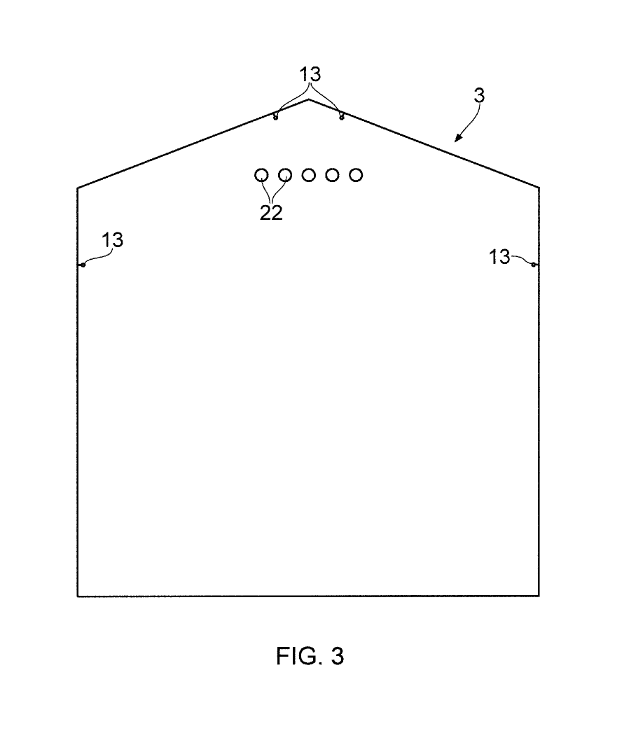

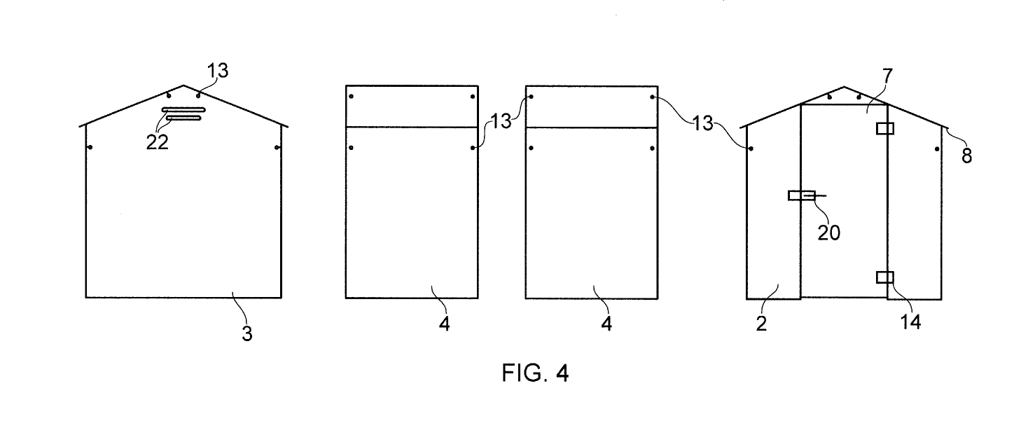

The clamps (9) shown in FIG. 1 have an inner layer (10) which is placed on the inside of the greenhouse (1), and an outer layer (11) which is held on the outside of the greenhouse. The inner layer (10) may be formed of a metal plate that is bent into a 90 degree (right angle) shape. Alternatively, the inner layer (10) may be formed of two separate metal plates arranged at 90 degrees to each other but not necessarily in contact with each other. The outer layer (11) may be formed of a metal plate that is bent into a 90 degree (right angle) shape. Alternatively, the outer layer (11) may be formed of two separate metal plates arranged at 90 degrees to each other but not necessarily in contact with each other. Each arm or part of the inner layer (10) has a hole (12) for receiving a bolt or screw. Drill holes (13) for the clamps to be attached to the panels by bolts or screws are shown in FIGS. 3 and 4. The bolt thus passes through the hole (12) in the inner layer (10) of clamp (9), through the drill hole (13) in the greenhouse panels, and into the outer layer (11) of the clamp to hold the panels and clamp (9) in place. The outer layer (11) of the clamp may also have a hole for receiving the bolt, so that the bolt passes thorough the outer layer (11) as well. In this case, a nut or other securing means may be provided on the outer side of the outer layer (11) to secure the bolt in position. Alternatively, a screw or other threaded member may be used instead of a bolt, and a threaded nut may be connected to the front end of the screw that protrudes from the outer layer and tightened to cause the inner and outer layers (11, 12) to securely grip the glass panel therebetween.

Each of the clamps (9) connects together two panels. The clamp (9) grips both of the panels to securely fasten the panels together. Adjacent panels may be connected together by a single clamp, or by more than one clamp, e.g. by two clamps. Where there are two clamps, the clamps may be spaced from one another, for example one of the clamps may be positioned adjacent to an upper edge of the glass panel and the second one of the clamps may be positioned adjacent to a lower edge of the glass panel.

As mentioned above, the front wall (2) has an opening (6) in which a door (7) is positioned. The door (7) is also made of 10 mm toughened glass. The transparent door panel is attached to the front wall panel by hinges (14). Suitable hinges for the door can be obtained from C.R. Laurence Company, Inc., for example Geneva 180° glass-to-glass hinge (Cat. No. GEN180). The hinges (14) are glass-to-glass hinges that directly connect the glass panel of the door (7) to the adjacent glass panel of the front wall (2). The hinge (14) has a central mechanism (15) surrounded by an attachment plate. The attachment plate has an inner layer (16) which is held on the inside of the greenhouse, and an outer layer (17) which is held on the outside of the greenhouse. The inner layer (16) has a hole for receiving a bolt. The wall and door panel on which the hinge is mounted have a cut-out (18) for the central mechanism (15), and drill holes (19) for receiving a bolt.

To hold the hinge in place, a bolt passes through the hole in the inner layer (16) of hinge (14), through the drill hole (19) in the greenhouse panels, and into the outer layer (17) of the hinge.

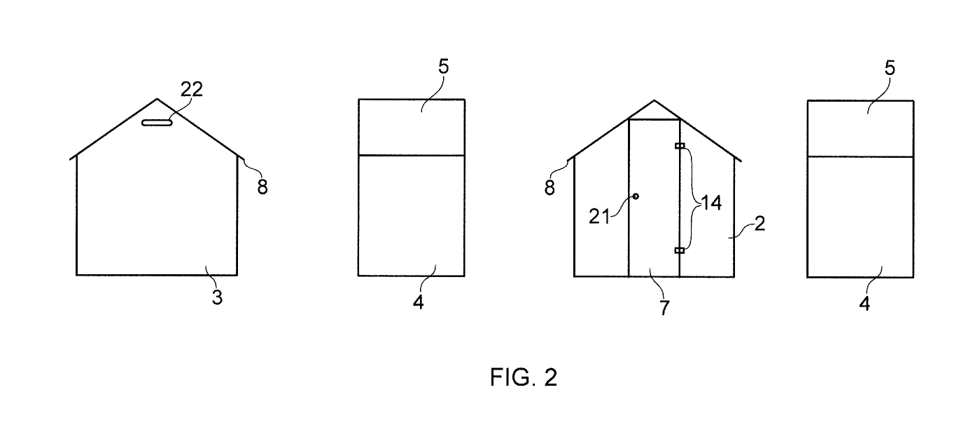

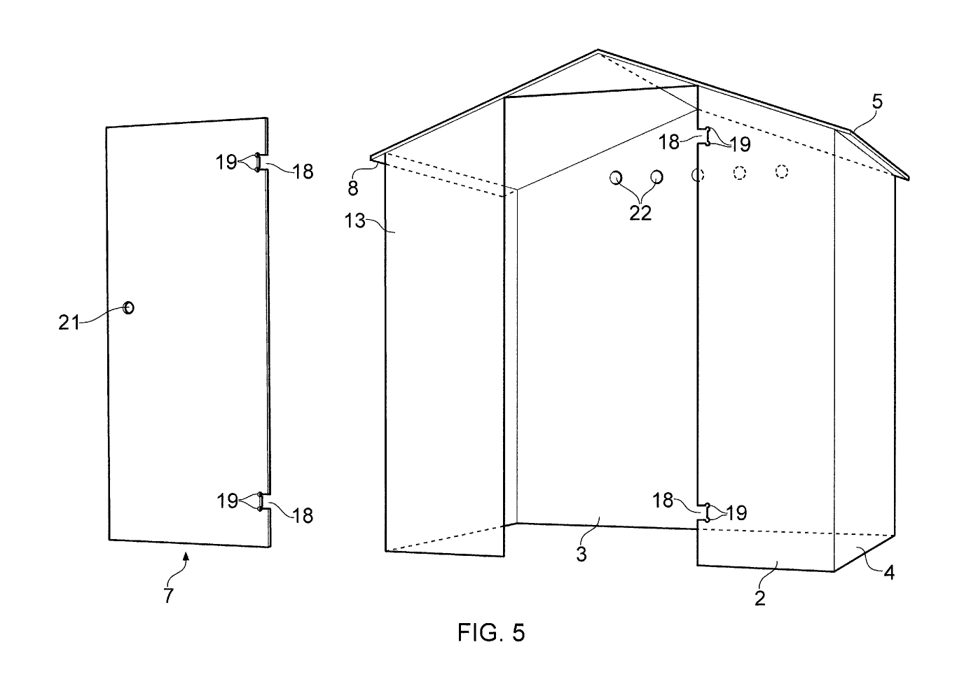

The door (7) in FIG. 1 may also have a handle (20) for opening the door (7), as shown in FIG. 4. The door (7) may have a hole (21), as shown in FIGS. 2 and 5 through which the handle (20) is attached. The base of the door (7) is held above the base of the walls by 5 mm to allow it to swing freely.

Of course, in other embodiments other door configurations may be used instead. For example, the door may be a sliding door. In other words, the door may be a panel that is slidably moveable in tracks or a guide to slidably open or close an opening in the wall of the greenhouse.

The rear wall may comprise air vents (22) as shown in FIGS. 2, 3, 4 and 5. FIGS. 2 and 4 show elongate air-vents. In alternative embodiment shown in FIGS. 3 and 5 the air-vents (22) are circular. The air vents shown in FIG. 3 are 100 mm in diameter.

The greenhouse in FIG. 2 is 1828 mm wide (as measure along the length of the front and rear walls), and 1220 mm deep (as measured along the length of side walls). It is 1965 mm tall at its tallest point.

Dow corning 993 structural glazing sealant is positioned between adjacent panels of the walls and roof.

The greenhouse in FIG. 1 is shown in situ, on a base (23). The bottom of the wall panels (2,3,4) is placed in a groove (24) which is raised above the base (23). The groove (24) is made of stainless steel.

1. A freestanding, frameless greenhouse, the greenhouse comprising a plurality of transparent glass panels which are fastened together by a plurality of connectors to form a wall and a roof, wherein the wall and roof enclose an interior, and wherein the connectors are clamps.

2. A greenhouse according to claim 1, wherein the panels form a plurality of walls.

3. A greenhouse according to claim 1, comprising a door.

4. A greenhouse according to claim 3, wherein the door is made of a transparent panel.

5. A greenhouse according to claim 3, wherein the door is made of glass.

6. A greenhouse according to claim 3, wherein the door is directly attached to a panel by a hinge.

7. A greenhouse according to claim 1, comprising an air vent.

8. A greenhouse according to claim 1, comprising a plurality of air vents.

9. A greenhouse according to claim 1, wherein the connectors are attached to the panels by screws or bolts.

10. A greenhouse according to claim 9, wherein the panels have holes for receiving the screws or bolts.

11. A greenhouse according to claims 1, wherein the panels are toughened glass panels.

12. A greenhouse according to claim 1, wherein the roof is a pitched roof.

13. A greenhouse according to claim 12, wherein the roof is dual-pitched.

14. A greenhouse according to claim 1, wherein the roof overhangs the wall.

15. A greenhouse according to claim 1, comprising sealant in the join between adjacent panels.

16. A kit of parts comprising a plurality of transparent panels and a plurality of connectors for assembling into a greenhouse according to any one of the previous claims.

17. An assembly comprising a greenhouse according to any one of claim 1, and a base, wherein the greenhouse rests on the base.

18. An assembly according to claim 17, wherein the base comprises a groove which is adapted to receive the base of the walls.
